(19) United States
(12) Patent Application Publication
(10) Pub. No.: US 2009/0051500 A1
(43) Pub. Date: Feb. 26, 2009

(54) RFID TAG FOR AUCTION BIDS, RFID TAG COMMUNICATION SYSTEM, AUCTION SYSTEM, AND SERVER FOR AUCTION BIDS

(75) Inventors: Mitsuru NAKAMURA, Kasugai-shi (JP); Kazuya NISHIMURA, Suzuka-shi (JP); Yasuhisa ICHIKAWA, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/196,525

(22) Filed: Aug. 22, 2008

(30) Foreign Application Priority Data
Aug. 24, 2007 (JP) 2007-218230

(51) Int. Cl. H04Q 5/22; G06Q 30/00

(52) U.S. Cl. 340/10.41; 340/10.1; 705/26

(57) ABSTRACT

A RFID circuit element provided with an IC circuit part that can store information and a tag antenna connected to the IC circuit part is provided, and the IC circuit part stores and holds auction site information including operator information such as login ID, password and the like and URL and the like of an auction site associated with each of a plurality of auction sites and product information such as product name/model number of a product the operator wants to successfully bid, a bidding price, quantity and the like.

### CROSS-REFERENCE TO RELATED APPLICATIONS

This application claims priority from JP 2007-218230, filed Aug. 24, 2007, the contents of which are hereby incorporated by reference.

### BACKGROUND OF THE INVENTION

1. Field of the Invention

The present invention relates to a RFID tag for auction bids in which reading or writing of RFID tag information can be carried out from outside through radio communication, a RFID tag communication system, an auction system, and a server for auction bids.

2. Description of the Related Art

A RFID (Radio Frequency Identification) system that carries out information reading/writing contactlessly between a small-sized RFID tag having a RFID circuit element provided with an IC circuit part storing predetermined RFID tag information and an antenna connected to the IC circuit part and carrying out information transmission/reception and a reader (reading device)/writer (writing device) has been proposed and is being put into practice in various fields.

An example of the practical use of the above RFID system is application to an auction system for publicly bidding and determining a successful-bidding price is (See JP, A, 2001-256376, for example). In this prior art, credit information, which is money information available for an owner, recorded in a RFID tag (prepaid card) is read out and determination can be made on whether or not the owner can participate in the auction based on the credit information.

Needs for auctions on the Internet have been increased recently due to spread of the Internet, and various auction sites exist in correspondence with the needs. In order for a user to obtain a desired goods using such plural auction sites, a complicated operation of logging into each site and searching for the desired goods and then, selecting a site suitable for the user's needs and making a bid is required, which is a troublesome task for the operator.

### SUMMARY OF THE INVENTION

An object of the present invention is to provide a RFID tag for auction bids, a RFID tag communication system, an auction system, and a server for auction bids that can improve convenience.

### BRIEF DESCRIPTION OF THE DRAWING

FIG. 1 is an entire block diagram illustrating an entire configuration of an auction system having a RFID tag for auction bids in an embodiment of the present invention.

FIG. 2 is a system block diagram illustrating a system configuration of an auction bidding system.

FIG. 3 is a functional block diagram illustrating an example of functional configuration of a RFID circuit element.

FIG. 4 is a diagram illustrating an example of data configuration of a memory part in an IC circuit part of the RFID circuit element of the RFID tag.

FIG. 5 is a conceptual time chart of operation procedures before a bidding executed by the auction bidding system.

FIG. 6 is a conceptual time chart of operation procedures after a bidding executed by the auction bidding system.

### DETAILED DESCRIPTION OF THE PREFERRED EMBODIMENTS

An embodiment of the present invention will be described below referring to the attached drawings.

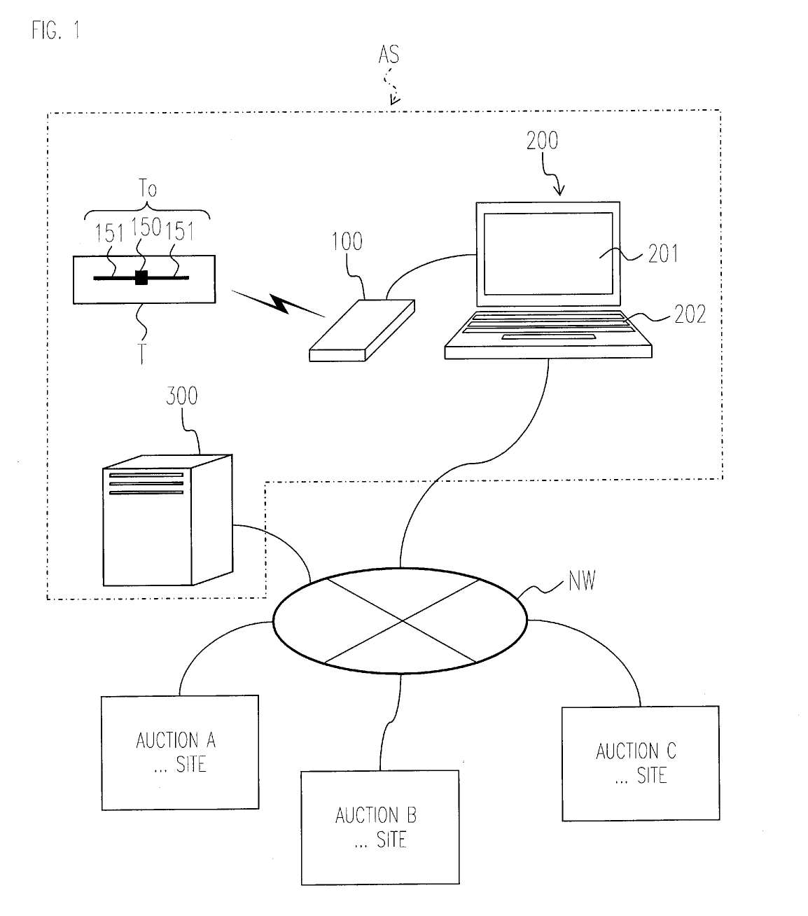

FIG. 1 is an entire block diagram illustrating an entire configuration of an auction system having a RFID tag for auction bids of this embodiment.

An auction system AS shown in FIG. 1 has a RFID tag T (RFID tag for auction bids) having a RFID circuit element To constituted by a tag antenna 151 configured to transmit/receive RFID tag information and an IC circuit part 150 connected thereto capable of storing RFID tag information, a reader/writer 100 configured to perform radio communication with the RFID tag T and to read or write the RFID tag information from/to the IC circuit part 150 of the RFID circuit element To, a terminal 200 (apparatus for communicating with a RFID tag) such as a PC connected to the reader/writer 100 capable of information transmission/reception and provided with a display portion 201 and an operation portion 202, and a server 300 (server for auction bids) connected capable of information transmission/reception through a communication line NW (Internet or the like) by wired or radio communication with the terminal 200 and capable of processing such as automatic bidding in a plurality of auction sites (auction sites A, B, C and the like) through the communication line NW.

The RFID tag T may incorporate the RFID circuit element To in a substantially rectangular card material such as an IC card, for example, or may be configured by bonding a RFID label formed in the label shape on the card material.

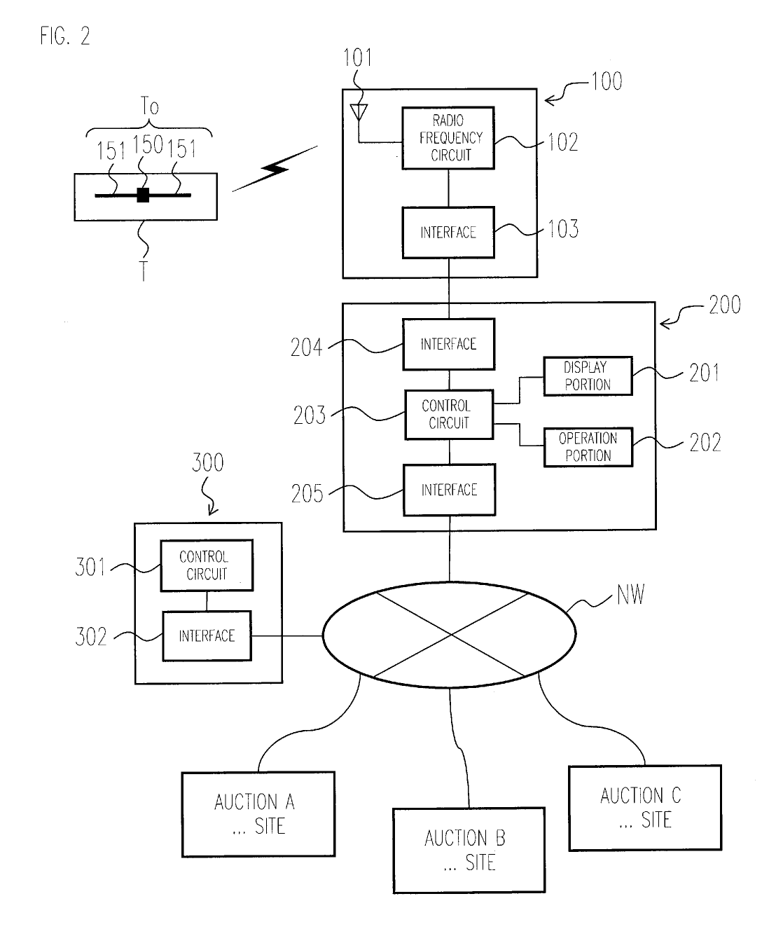

FIG. 2 is a system block diagram illustrating a system configuration of the auction bidding system AS.

The reader/writer 100 has an antenna 101 (antenna device) configured to transmit/receive a signal by radio communication with the tag antenna 151 of the RFID circuit element To provided at the RFID tag T, a radio frequency circuit 102 configured to access the IC circuit part 150 of the RFID circuit element To through the antenna 101 by radio communication and to process the signal read out of the RFID circuit element To, and an interface 103 configured to input/output information with a control circuit 203 of the terminal 200.

The terminal 200 has an operation portion 202 configured to carry out various operation inputs by an operator, a display portion 203 configured to make various displays, an interface 204 configured to carry out input/output of information with the radio frequency circuit 102 of the reader/writer 100, an interface 205 configured to perform network communication conducted with a control circuit 301 of the server 300 through the communication line NW, and the control circuit 203 connected to the display portion 201, the operation portion 202, and the interfaces 204, 205 and configured to execute control of the entire terminal 200. The control circuit 203 also executes control of the radio frequency circuit 102 of the reader/writer 100.

The server 300 has the control circuit 301 configured to execute control of the entire server 300 and an interface 302 configured to perform network communication among the control circuit 301, the control circuit 203 of the terminal 200 and servers and the like, not shown, of a plurality of auction sites conducted through the communication line NW.

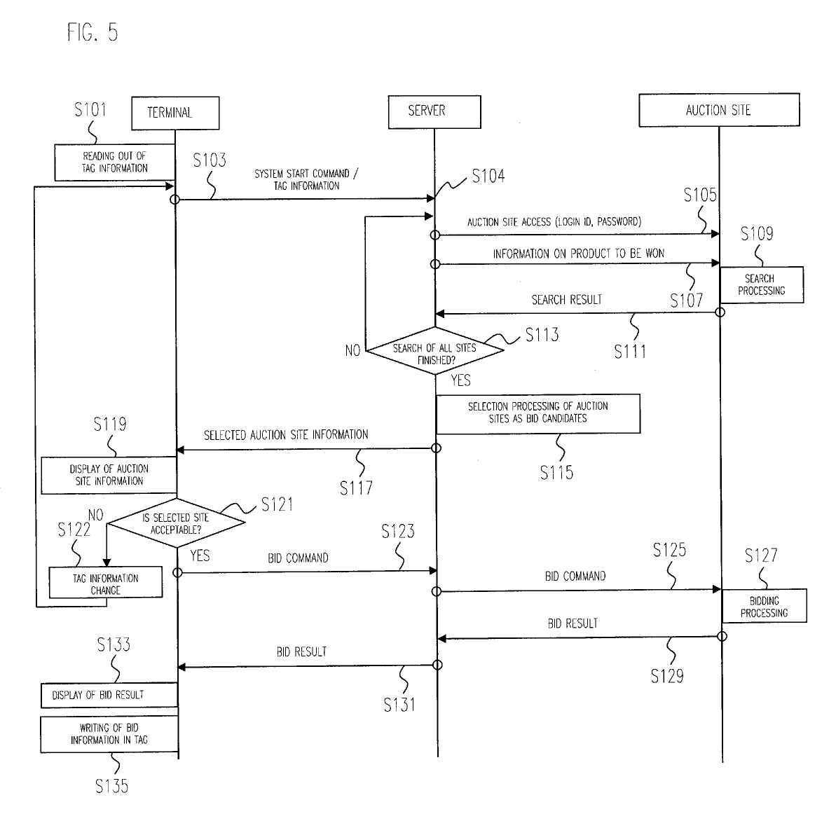

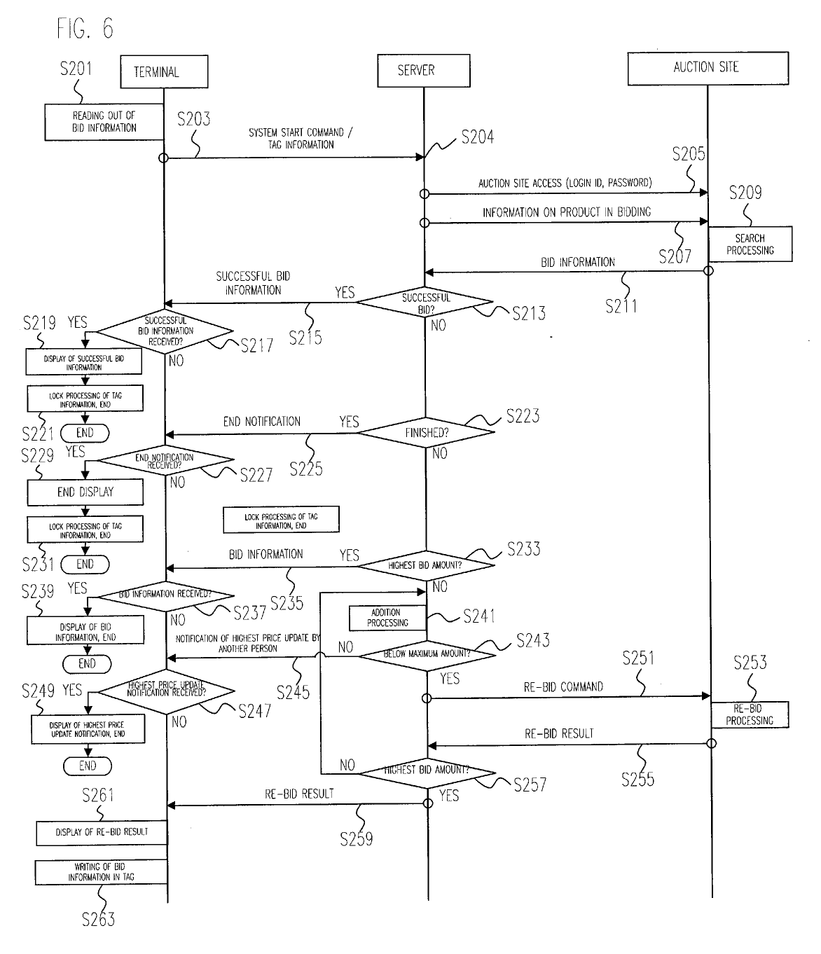

The control circuit 203 of the terminal 200 and the control circuit 301 of the server 300 are so-called micro computers, though not particularly shown, and are each configured by a CPU, which is a central processing unit, a ROM, a RAM and the like to execute predetermined processing procedures (processing procedures shown in FIGS. 5 and 6, which will be described later, for example) according to a program stored in the ROM in advance using a temporary memory function of the RAM.

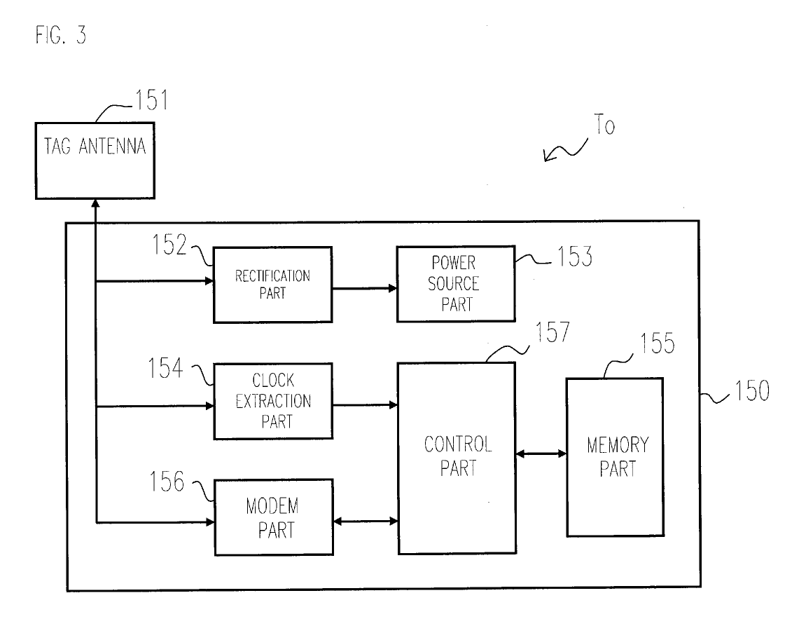

FIG. 3 is a functional block diagram illustrating an example of functional configuration of the RFID circuit element To. As mentioned above, the RFID circuit element To includes the tag antenna 151 and the IC circuit part 150. An arrow shown in the figure is an example of flow of a signal and does not limit the flow direction of the signal.

The IC circuit part 150 obtains electric power from a carrier wave for power source (interrogation wave) transmitted by the reader/writer 100, executes internal processing according to a command from the reader/writer 100 and then, transmits a response signal to the reader/writer 100. Thus, the IC circuit part 150 has a rectification part 152 configured to rectify the interrogation wave received by the tag antenna 151, a power source part 153 configured to accumulate energy of the interrogation wave rectified by the rectification part 152 so as to make it a driving power source, a clock extraction part 154 configured to extract a clock signal from the interrogation wave received by the tag antenna 151 and to supply it to a control part 157, a memory part 155 that can store predetermined information signals, a modem part 156 connected to the tag antenna 151, and the control part 157 configured to control operation of the RFID circuit element To through the memory part 155, the clock extraction part 154, the modem part 156 and the like.

The modem part 156 demodulates a communication signal from the reader/writer 100 received by the tag antenna 151 and modulates a reply signal from the control part 157 and transmits it to the tag antenna 151 as a response wave.

The control part 157 executes a basic control such as interpretation of a received signal demodulated by the modem part 156, generation of a reply signal based on the information signal stored in the memory part 155, reply of it by the modem part 156 and the like.

The clock extraction part 154 extracts a clock component from the received signal and extracts it to the control part 157 and supplies the clock corresponding to a frequency of the clock component of the received signal to the control part 157.

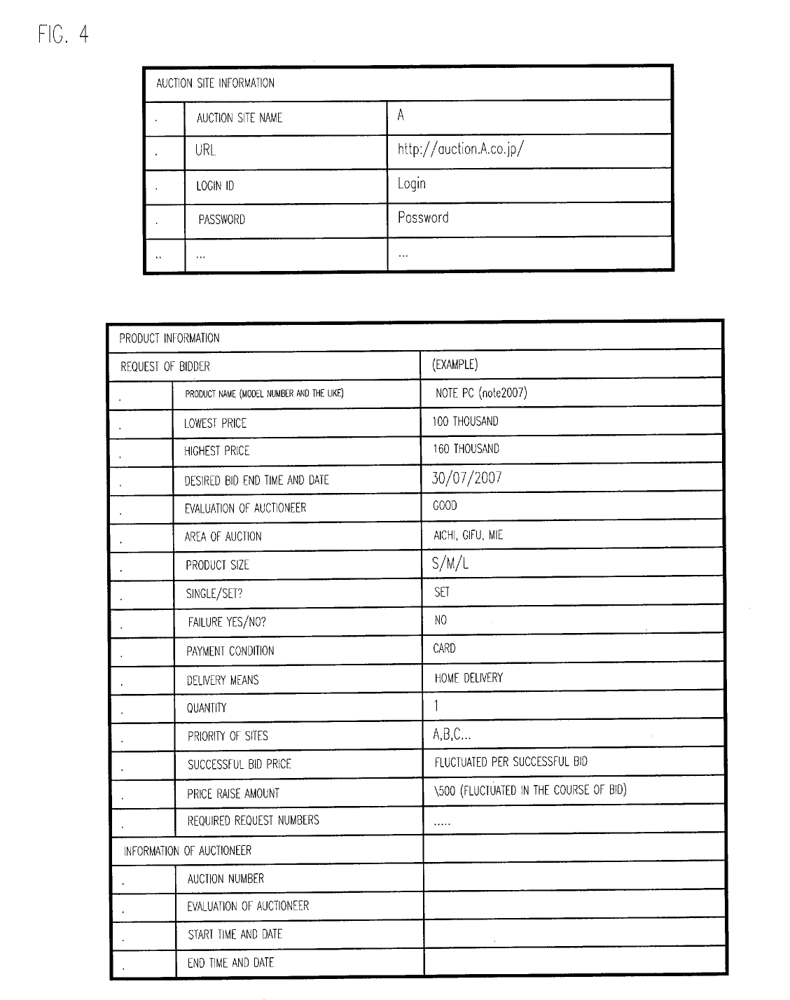

FIG. 4 is a diagram illustrating an example of data configuration of the memory part 155 of the IC circuit part 150 in the RFID circuit element To of the RFID tag T.

In an example shown in FIG. 4, the memory part 155 of the IC circuit part 150 in the RFID circuit element To stores and holds information on a plurality of auction sites associated with each of the plurality of auction sites and product information (bidding product information) regarding the product desired by an operator, set in common to the plurality of auction sites. The auction site information has names and URLs (address information) of the auction sites and operator information consisting of a login ID (personal identification information) in order to participate in the auction site, a password and the like owned by the operator.

The product information includes product name (including model number and the like) as product identification information, lowest price (bidding price) as bidding price information, highest price (maximum bidding price) allowable for a successful bid, price raise amount (increase amount) of the price increased at each re-bidding from the lowest price to the highest price, quantity of the product and the like. In the example shown in FIG. 4, in addition to the above as the product information, desired time and date of bid closing, evaluation of auctioneers, area of auction, product size, single product or a set product, presence of failure, payment condition, delivery portion, priority of sites, items required as a request of a bidder among the above, other information of the auctioneer (auction number, evaluation of auctioneer, start time and date, end time and date) and the like are included, but information other than those described herein may be included.

FIG. 5 is a conceptual time chart of an operation procedure before a bidding executed by the auction bidding system AS.

First, the control circuit 203 of the terminal 200 performs reading out of RFID tag information from the RFID circuit element To of the RFID tag T through the reader/writer 100 (Step S101). Specifically, the control circuit 203 of the terminal 200 transmits a control signal to the radio frequency circuit 102 of the reader/writer 100 through the interfaces 204, 103, transmits an interrogation wave subjected to predetermined modulation as a signal to read out the RFID tag information stored in the memory part 155 of the RFID circuit element To of the RFID tag T to the RFID circuit element To of the RFID tag T present in a communication range through the antenna 101 of the reader/writer 100 and prompts a reply. This procedure is repeated till a reply is made from the RFID tag T. When the operator holds the RFID tag T over the reader/writer 100 and the like and the RFID tag T enters the communication range of the reader/writer 100, a reply signal is returned from the RFID circuit element To of the RFID tag T. The control circuit 203 takes in the returned reply signal through the antenna 101, the radio frequency circuit 102, and the interfaces 103, 204 and acquires the RFID tag information based on the reply signal. The RFID tag information includes the above-mentioned auction site information and the product information (See FIG. 4).

The control circuit 203 of the terminal 200 that acquired the RFID tag information from the RFID tag T as above transmits a system start command and the acquired RFID tag information to the server 300 through the interface 205 and the communication line NW (Step S103).

The control circuit 301 of the server 300 that receives the RFID tag information transmitted from the terminal 200 through the interface 302 (Step S104), accesses the auction site through the communication line NW based on the auction site information in the RFID tag information, and makes a search based on the product information in the RFID tag information. Specifically, the control circuit accesses the site based on URL in the auction site information and transmits the log in ID and password of the operator so as to participate in the site (so-called login) (Step S105). After that, the product information is transmitted (Step S107), and search processing is conducted by a server (not shown) of the auction site (Step S109).

The server of the auction site (not shown) transmits the search result to the server 300 through the communication line NW (Step S111). The control circuit 301 of the server 300 that receives the search result transmitted from this site through the interface 302 determines whether or not all the searches have been finished for the plurality of auction sites included in the auction site information (Step S113). If the searches have not been finished, the process returns to the preceding Step S105, where an access is made to the subsequent auction site through the communication line NW and a search is made based on the product information in the RFID tag information.

When the product search has been finished for all the auction sites as above, the control circuit 301 of the server 300 executes selection processing of the auction site based on the search result received from each auction site (Step S15). The selection of the auction site is made based on the priority if the site priority has been set by the operator (See item 13 in the product information in FIG. 4), while if the priority is not set, a site most suitable for the request of the auctioneer is selected based on the other conditions in the product information (See FIG. 4). If there is a plurality of sites suitable for the request of the auctioneer, a site is selected so that a successful bid can be made with the lowest price (by selecting a site without other bids or by comparing the highest bidding price by the others of each of the plurality of auction sites and selecting an auction site with the lowest price, for example). Then, the control circuit 301 of the server 300 transmits the information on the selected site and the product search result in the site to the terminal 200 through the communication line NW (Step S117).

The control circuit 203 of the terminal 200 having received the site information and search results transmitted from the server 300 through the interface 205 displays the information by outputting a control signal to the display portion 201 (Step S119). Then, it is determined whether or not the selected site is acceptable based on the operation signal input by the operator through the operation portion 202 (Step S121). If the operator makes an input that the site selected is not acceptable through the operation portion 202, the operator can change the RFID tag information (auction site information and product information) on the terminal 200 (Step S122), and then, the process returns to the previous step S103. Then, the control circuit 203 of the terminal 200 transmits the RFID tag information changed by the operator, and the system start command to the server 300 again (Step S103). By this operation, the control circuit 301 of the server 300 newly accesses the auction site based on the auction site information in the changed RFID tag information and makes a search again based on the changed product information (Step S109).

On the other hand, if the operator makes an input that the site selected is acceptable through the operation portion 202, the control circuit 203 of the terminal 200 transmits a bid command to the server 300 through the interface 205 and the communication line NW (Step S123).

The control circuit 301 of the server 300 which has received the bid command transmitted from the terminal 200 through the interface 302 transmits the bid command to the auction site selected at Step S115 (Step S125) and has the server (not shown) of the auction site execute the bidding processing (Step S127). The bidding price at this time is set at a lowest price in the product information (See the item 2 in the product information in FIG. 4). Since the subsequent procedures (Step S105 to Step S123) are carried out while logging into the auction site at Step S105, another login is not necessary at this bidding.

The server (not shown) of the auction site transmits the above bid result to the server 300 through the communication line NW (Step S129).

The control circuit 301 of the server 300 having received the bid result transmitted from the site through the interface 302 transmits the bid result to the terminal 200 through the communication line NW (Step S131). Though particular description has not been made here, when a bid is made by setting the bidding price at the lowest price in the product information (See the item 2 in the product information in FIG. 4), for example, if a lowest bidding price is set higher than the price by an auctioneer or if a bid has been already made by another person at an price higher than that, a bidding price may be set again by appropriate processing such as addition of a raise amount (See the item 15 in the product information in FIG. 4) to the price and another bid may be made.

The control circuit 203 of the terminal 200 having received the bid result transmitted from the server 300 through the interface 205 displays the bid result by outputting a control signal to the display portion 201 (Step S133). Then, writing of the bid information (auction site information of the auction site in which the bid was made, the bidding price and the like) is made to the RFID circuit element To of the RFID tag T through the reader/writer 100 (Step S135). Specifically, the control circuit 203 of the terminal 200 transmits a control signal to the radio frequency circuit 102 of the reader/writer 100 through the interfaces 204, 103 and transmits the carrier wave subjected to predetermined modulation as a signal to write the RFID tag information in the memory part 155 of the RFID circuit element To of the RFID tag T to the RFID circuit element To of the RFID tag T present in the communication range through the antenna 101 of the reader/writer 100. As a result, the bid information is written in the memory part 155 of the RFID circuit element To.

The time chart does not limit the present invention to the procedure shown in the chart, but addition/deletion or change of order and the like may be carried out in a range not departing from the gist and technical idea of the invention.

FIG. 6 is a conceptual time chart of an operation procedure after a bidding executed by the auction bidding system AS.

First, the control circuit 203 of the terminal 200 conducts reading out of the RFID tag information from the RFID circuit element To of the RFID tag T through the reader/writer 100 (Step S201). This procedure is repeated till a reply is given by the RFID tag T. When a reply signal is returned from the RFID circuit element To of the RFID tag T, the control circuit 203 takes in the returned reply signal through the antenna 101, the radio frequency circuit 102, and the interfaces 103, 204 and acquires the RFID tag information based on the reply signal. This RFID tag information includes the above-mentioned bid information (auction site information of the auction site in which the bid is made, the bidding price and the like).

The control circuit 203 of the terminal 200 having acquired the RFID tag information from the RFID tag T as above transmits the system start command and the above-acquired RFID tag information to the server 300 through the interface 205 and the communication line NW (Step S203).

The control circuit 301 of the server 300 having received the RFID tag information transmitted from the terminal 200 through the interface 302 (Step S204) makes an access to the auction site through the communication line NW based on the bid information in the RFID tag information and makes a search based on the product information. Specifically, an access is made to the site based on the URL of the auction site in which the bid was made, and the login ID and password of the operator are transmitted so as to login the site (Step S205). After that, the product information in the bid is transmitted (Step S207) and search processing is executed by the server (not shown) of the auction site (Step S209).

The server (not shown) of the auction site transmits the search result to the server 300 through the communication line NW (Step S211). The control circuit 301 of the server 300 having received the bid information, which is the search result transmitted from the site through the interface 302 determines if the operator made a successful bid for the product or not based on the bid information (Step S213). If the bid was successful, the control circuit 301 of the server 300 transmits the successful bid information (successful-bid notification) including at least the auction site information of the auction site in which the successful bid was made and the successful-bidding price information to the terminal 200 through the communication line NW (Step S215).

On the other hand, the control circuit 203 of the terminal 200 determines if the successful bid information has been received or not from the server 300 through the communication line NW (Step S217). If it has been received, a control signal is output to the display portion 201 so as to display the successful bid information (Step S219). Then, lock processing is performed for the RFID circuit element To of the RFID tag T so that reading of the RFID tag information is disabled through the reader/writer 100 (Step S221). Specifically, the control circuit 203 of the terminal 200 transmits a control signal to the radio frequency circuit 102 of the reader/writer 100 through the interfaces 204, 103 and transmits a carrier wave subjected to predetermined modulation as a signal to give a command to prohibit response by the control portion 157 of the IC circuit part 150 of the RFID circuit element To the RFID circuit element To of the RFID tag T present in the communication range through the antenna 101 of the reader/writer 100. By this operation, the control part 157 of the RFID circuit element To prohibits response to the subsequent commands. As a result, the bidding function with radio communication with the RFID tag T in the server 300 is invalidated.

In the above, the bidding function of the server 300 is invalidated by preventing reading-out of the RFID tag information of the RFID tag T, but not limited to that, the bidding function may be invalidated on the side of the terminal 200 or the server 300 by not transmitting information by the terminal 200 to the server 300 though the RFID tag information of the RFID tag T can be read out or by not transmitting information by the server 300 to the auction site and the like.

In the above Step S213, if the control circuit 301 of the server 300 determines that the operator has not made a successful bid for the product based on the bid information received from the auction site, it is determined if the auction has been finished or not based on the bid information (Step S223). If the auction has been finished, the control circuit 301 of the server 300 transmits an auction end notification to the terminal 200 through the communication line NW (Step S225).

On the other hand, the control circuit 203 of the terminal 200 determines whether or not the auction end notification has been received from the server 300 through the communication line NW (Step S227). If the notification has been received, a control signal is output to the display portion 201 so as to display the end notification (Step S229). Then, the lock processing to disable reading-out of the RFID tag information is executed for the RFID circuit element To of the RFID tag T through the reader/writer 100 (Step S231). By this arrangement, the control part 157 of the RFID circuit element To prohibits response to the subsequent commands.

In the above Step S223, if the control circuit 301 of the server 300 determines that the auction has not been finished based on the bid information received from the auction site, it determines whether or not the bidding price by the operator is on the highest bid side based on the bid information (Step S233). If it is on the highest bid side, the control circuit 301 of the server 300 transmits the bid information to the terminal 200 through the communication line NW (Step S235).

On the other hand, the control circuit 203 of the terminal 200 determines whether or not the bid information has been received from the server 300 through the communication line NW (Step S237). If it has been received, a control signal is output to the display portion 201 so as to display the bid information (Step S239).

In the above Step S233, if the control circuit 301 of the server 300 determines that the bidding price by the operator is not on the highest bid side based on the bid information received from the auction site, the addition processing to add a raise amount (See the item 15 in the product information in FIG. 4) to the bidding price (Step S241). After that, it is determined whether or not the added price is below the highest price allowable for a successful bid (See the item 3 in the product information in FIG. 4) (Step S243). If the price is higher than the highest price, the control circuit 301 of the server 300 transmits a notification that a highest price has been updated by another person to the terminal 200 through the communication line NW (Step S245).

On the other hand, the control circuit 203 of the terminal 200 determines whether or not the highest price update notification by another person has been received from the server 300 through the communication line NW (Step S247). If the notification has been received, a control signal is output to the display portion 201 so as to display the highest price update notification (Step S249).

In the above Step S243, if it is determined that the added price is below the highest price, the control circuit 301 of the server 300 transmits a re-bid command to the auction site (Step S251) so as to execute re-bid processing by the server (not shown) of the auction site (Step S253). The server (not shown) of the auction site transmits a result of the re-bidding to the server 300 through the communication line NW (Step S255).

The control circuit 301 of the server 300 having received re-bid result transmitted from the site through the interface 302 determines whether or not the re-bidding price by the operator is on the highest bid side based on the received re-bid results (Step S257). If it is not the highest bidding price, the process returns to the previous Step S241, the addition processing is executed again, and a bid is made again if the price is below the highest price. On the other hand, if the price is on the highest bidding price, the control circuit 301 of the server 300 transmits the re-bid result to the terminal 200 through the communication line NW (Step S259).

The control circuit 203 of the terminal 200 having received the re-bid result transmitted from the server 300 through the interface 205 outputs a control signal to the display portion 201 so as to display the re-bid result (Step S261). Then, the re-bid information is written in the RFID circuit element To of the RFID tag T through the reader/writer 100 (Step S263).

In the time chart shown in FIGS. 5 and 6, the procedures in Step S101 and Step S201 executed by the control circuit 203 of the terminal 200 constitute a first information acquisition portion configured to acquire auction site information and operator information relating to a plurality of auction sites from the IC circuit part of the RFID tag for auction bids through the antenna device described in each claim and also constitute a second information acquisition portion configured to acquire the auction site information, operation information and bid product information relating to the plurality of auction sites from the IC circuit part of the RFID tag for auction bids through the antenna device. Also, the procedures of Step S105 and Step S205 executed by the control circuit 301 of the server 300 constitute an access processing portion configured to execute access processing to the plurality of auction sites using the auction site information and operator information acquired by the first information acquisition portion.

Moreover, procedures of Step S105, Step S205, Step S115, Step S125 and Step S251 executed by the control circuit 301 of the server 300 constitute a bid processing portion configured to execute bid processing to the plurality of auction sites using the auction site information, operator information, and bid product information acquired by the second information obtaining portion, and the procedures of Step S105 and Step S205 among them constitute a participation processing portion configured to access each of the plurality of auction sites based on the address information and to execute participation processing to each auction site using corresponding personal identification information and password, respectively, and the procedures in Step S115, Step S125 and Step S251 constitute an automatic bidding portion configured to make an automatic bidding in the auction site for which the participation processing has been completed by the participation processing portion using the product identification information, quantity information, and bidding price information.

Also, the procedure in Step S15 executed by the control circuit 301 of the server 300 constitute a site determining portion configured to compare the highest bidding price of another person in each of the plurality of auction sites at participation by the participation processing portion and to determine the auction site with the lowest price, and Step S104 and Step S204 constitute an information input portion configured to input address information of each of the plurality of auction sites, personal identification information and password owned by the operator for participating in the auction site, product identification information, quantity information, and bidding price information acquired by the apparatus for communicating with a RFID tag from the RFID tag for auction bids through the antenna device.

Moreover, the procedures in Step S233 and Step S257 executed by the control circuit 301 of the server 300 constitute a comparing portion configured to compare the highest bidding price by another person in the auction site determined by the site determining portion described in each claim with the bidding price, the procedure in Step S241 constitutes an adding portion configured to add an increase amount to the bidding price if the bidding price is lower than the highest bidding price by another person as determined by the comparing portion, and the procedure in Step S251 constitutes a re-bidding portion configured to execute a re-bidding in a range not exceeding the maximum bidding price using the bidding price after addition by the adding portion.

The procedure in Step S213 executed by the control circuit 301 of the server 300 constitutes a successful-bid notification portion configured to output a successful-bid notification including at least the auction site information of the auction site of the successful bid and the successful-bidding price information when successful bid of the corresponding product is made by an automatic bidding by the automatic bidding portion, and the procedure in Step S223 constitutes an end notification portion configured to output an end notification to notify that successful bid of the corresponding product is not made within an auction period by the automatic bidding by the automatic bidding portion and the auction ends. Moreover, the procedure in Step S221 or Step S231 constitutes an invalidation processing portion configured to invalidate the automatic bidding function of the automatic bidding portion with radio communication with the RFID tag for auction bids through the antenna device after the successful-bid notification is output by the successful-bid notification portion or the end notification is output by the end notification portion.

The time chart does not limit the present invention to the procedures shown in the chart but addition/deletion or change of order or the like may be made within a range not departing from the gist and technical idea of the invention.

In the above, the RFID tag T, the antenna 101 of the reader/writer 100, and the terminal 200 (in detail, Step S101 executed by the control circuit 203 of the terminal 200) constitute the RFID tag communication system described in each claim. Also, the RFID tag T, the antenna 101 of the reader/writer 100, the terminal 200 (in detail, Step S101 executed by the control circuit 203 of the terminal 200), and the server 300 (in detail, Step S125 executed by the control circuit 301 of the server 300) constitute the auction system.

In the above-described embodiment, the auction site information and product information including the operator information associated with each of the plurality of auction sites are stored and held in the IC circuit part 150 of the RFID circuit element To. As a result, by acquiring the information on the terminal 200 side (including the server 300) through the reader/writer 100, an access can be made sequentially to the plurality of auction sites using the auction site information. Then, login is made to the auction of each site using the operator information in the auction site information and a bid can be made for the applicable product in the auction using the product information. That is, only by reading the RFID tag T by the terminal 200 side, a bid can be automatically made for the desired goods easily while searching auctions in the plurality of auction sites. Therefore, time required for procedures of a search of goods desired by the operator and auction bidding can be reduced, and convenience can be improved.

Particularly in this embodiment, each URL of the plurality of auction sites is stored and held as the auction site information in the IC circuit part 150 of the RFID circuit element To. As a result, by acquiring the URL of each site on the terminal 200 side, an access can be made sequentially to the plurality of auction sites using that.

Also, particularly in this embodiment, the login ID and password owned by the operator for participating in the auction site are stored and held in the IC circuit part 150 of the RFID circuit element To for participating in each auction site as the operator information. As a result, by acquiring the login ID and password for each auction on the terminal 200 side, a login can be made sequentially to the plurality of auction sites using that.

Also, particularly in this embodiment, the bidding price information including the product name (including model number and the like), quantity, the lowest price and the like is stored and held in the IC circuit part 150 of the RFID circuit element To in common to the plurality of auction sites as the product information. As a result, by acquiring the information in common to each auction on the terminal 200 side, a bid can be made for the applicable product in the auction using that.

Also, particularly in this embodiment, the lowest price, the highest price allowable for a successful bid, and a price raise amount at each re-bidding from the lowest price to the highest price are stored and held in the IC circuit part 150 of the RFID circuit element To in common to the plurality of auction sites as the bidding price information. By this arrangement, when participating in an auction and making a bid, re-bidding by a bidding price in which an increase amount is added can be repeated till the maximum bidding price is reached if the bidding price at that time falls below the highest bidding price by another person.

Also, particularly in this embodiment, an access and login to each auction site are carried out each time information acquisition by the terminal 200 is carried out by new radio communication through the antenna 101 of the reader/writer 100. By this arrangement, each time the RFID tag T is read out, an access and login to each auction site can be repeated. As a result, an access and login to the auction site can be made again after various conditions at bidding in the RFID tag information stored and held in the RFID circuit element To of the RFID tag T are changed/updated.

Also, particularly in this embodiment, the automatic bidding for the auction site for which login is completed is made using the product information (product name, quantity, bidding price information and the like) in the RFID tag information. By automatically bidding in the site for which login is completed as above, a bid can be made automatically for a desired goods easily while searching auctions in the plurality of auction sites.

Also, particularly in this embodiment, the automatic bidding is executed so that a successful bid can be made at a lowest price in a range not exceeding the highest price by monitoring the highest bidding price of another person. By this arrangement, when participating in each auction and making a bid, re-bidding by a bidding price in which an increase amount is added can be repeated till the maximum bidding price is reached if the bidding price at that time falls below the highest bidding price by another person.

Also, particularly in this embodiment, the highest bidding prices of other persons at each of the plurality of auction sites at login are compared, the auction site with the lowest price is determined, and an automatic bidding is made for the determined auction site. By this arrangement, an automatic bidding can be made for the auction of the site capable of successful bid with the lowest price at that time.

Also, particularly in this embodiment, when successful bid of the corresponding product is made by the automatic bidding by the server 300, the successful bid information including at least the auction site information of the auction site with successful bid and the successful-bidding price information is output. By this arrangement, the fact that successful bid of the product is made in a range of desired bid condition by the automatic bidding can be notified to the operator.

Also, particularly in this embodiment, if the auction is finished without successful bid of the corresponding product by the automatic bidding by the server 300 within an auction period, the end notification notifying that is output. By this arrangement, the fact that successful bid of the product is not made in the desired bid condition by the automatic bidding can be notified to the operator.

Also, particularly in this embodiment, when the successful bid information is received or when the end notification is received by the terminal 200 from the server 300, the bidding function with radio communication with the RFID tag T through the antenna 101 of the reader/writer 100 after that is invalidated. By this arrangement, if the operator can make a successful bid or if the auction ends without successful bid, a wrong reading of the RFID tag T and an execution of automatic bidding with the same bid condition again can be prevented.

In the above, the lowest price, the highest price and the raise amount are stored and held in the RFID circuit element To of the RFID tag T as bidding price information and a bid is made by the server 300 at the lowest price at the initial bidding, but not limited to that. For example, it may be so configured that the lowest price is not stored in the RFID circuit element To but an price exceeding the bidding price of another person (a price obtained by adding a raise amount to a bidding price of another person) is set by the server 300 below the highest price and a bid is made by that bidding price. Alternatively, since the raise amount of the bidding price might be specified by the side of an auctioneer, for example, depending on the auction site, if such a site is to be used, the raise amount information does not have to be included in the bidding price information.

Also, in the above, a bid is made for a single auction site selected by the selection processing of the server 300, and monitoring is executed by accessing only the site in which the bid is made after that, but not limited to that. For example, it may be so configured that the operator makes a bid in a plurality of sites in which a desired product is auctioned and then, the highest bidding price of another person in each auction is monitored and prices of re-bid are adjusted or the like so that a successful bid can be made at the lowest price.

Also, in the above, radio communication between the RFID circuit element To of the RFID tag T and the antenna 101 of the reader/writer 100 was not particularly described, but information transmission/reception may be made by electric-wave communication using the UHF band, for example, or a coil-shaped loop antenna may be used as the antenna 101 of the reader/writer 100 and the tag antenna 151 on the side of the RFID circuit element To so as to perform the information transmission/reception by magnetic induction (including electromagnetic induction, magnetic coupling, and other non-contact method carried out through the electromagnetic field) using the HF band.

Other than those mentioned above, methods of the embodiments and their variations may be combined as appropriate for use.

Though not specifically exemplified, the present invention should be put into practice with various changes made in a range not departing from its gist.

What is claimed is:

1. A RFID tag for auction bids comprising:
a RFID circuit element provided with an IC circuit part configured to store information and a tag antenna connected to said IC circuit part, wherein:
said IC circuit part stores and holds auction site information, operator information, and bid product information associated with each of a plurality of auction sites.

2. A RFID tag for auction bids according to claim 1, wherein:
said IC circuit part stores and holds address information of each of said plurality of auction sites as said auction site information.

3. A RFID tag for auction bids according to claim 2, wherein:
said IC circuit part stores and holds personal identification information and password owned by said operator in order to participate in said auction site for each auction site as said operator information.

4. A RFID tag for auction bids according to claim 2, wherein:
said IC circuit part stores and holds product identification information, quantity information, and bidding price information in common to said plurality of auction sites as said bid product information.

5. A RFID tag for auction bids according to claim 4, wherein:
said IC circuit part stores and holds a maximum bidding price allowable for a successful bid in common to said plurality of auction sites as said bidding price information.

6. A RFID tag for auction bids according to claim 5, wherein:
said IC circuit part stores and holds a bidding price and an increase amount at each re-bidding from said bidding price to said maximum bidding price as well as said maximum bidding price, in common to said plurality of auction sites as said bidding price information.

7. A RFID tag communication system comprising:
a RFID tag for auction bids having a RFID circuit element provided with an IC circuit part configured to store information and a tag antenna connected to said IC circuit part, said IC circuit part storing and holding at least auction site information and operator information associated with each of a plurality of auction sites,
an antenna device configured to perform a radio communication with said RFID tag for auction bids; and
a first information acquisition portion configured to acquire said auction site information and said operator information relating to said plurality of auction sites from said IC circuit part of said RFID tag for auction bids through said antenna device.

8. A RFID tag communication system according to claim 7, further comprising an access processing portion configured to perform access processing to said plurality of auction sites using said auction site information and said operator information acquired by said first information acquisition portion.

9. An auction system comprising:
a RFID tag for auction bids having a RFID circuit element provided with an IC circuit part configured to store information and a tag antenna connected to said IC circuit part, said IC circuit part storing and holding auction site information, operator information, and bid product information associated with each of a plurality of auction sites;
an antenna device configured to perform a radio communication with said RFID tag for auction bids;
a second information acquisition portion configured to acquire said auction site information, said operator information, and bid product information relating to said plurality of auction sites from said IC circuit part of said RFID tag for auction bids through said antenna device; and
a bidding processing portion configured to perform a bidding processing to said plurality of auction sites using said auction site information, said operator information, and said bid product information acquired by said second information acquisition portion.

10. An auction system according to claim 9, wherein:
said IC circuit part of said RFID tag for auction bids stores and holds address information of each of said plurality of auction sites as said auction site information and stores and holds personal identification information and password owned by said operator for participating in said auction site for each auction site as said operator information; and
said bidding processing portion includes a participation processing portion configured to access each of said plurality of auction sites based on said address information and to execute a participation processing to each auction site using said corresponding personal identification information and said password.

11. An auction system according to claim 10, wherein:
said participation processing portion performs an access to each auction site and said participation processing every time a radio communication is newly performed through said antenna device and information is newly acquired by said second information acquisition portion.

12. An auction system according to claim 11, wherein:
said IC circuit part of said RFID tag for auction bids stores and holds product identification information, quantity information, and bidding price information in common to said plurality of auction sites as said bid product information; and
said bidding processing portion includes an automatic bidding portion configured to execute an automatic bid in an auction site for which participation processing has been completed by said participation processing portion using said product identification information, said quantity information, and said bidding price information.

13. An auction system according to claim 12, wherein:
said IC circuit part of said RFID tag for auction bids stores and holds a bidding price, a maximum bidding price allowable for a successful bid, and an increase amount at each re-bidding from said bidding price to said maximum bidding price in common to said plurality of auction sites as said bidding price information; and
said automatic bidding portion executes said automatic bidding so that a lowest successful bid can be made in a range not exceeding said maximum bidding price by monitoring the highest bidding price of another person for each of said plurality of auction sites.

14. An auction system according to claim 13, wherein:
said automatic bidding portion includes a site determining portion configured to compare the highest bidding price of another person in each of said plurality of auction sites at participation by said participation processing portion and to determine an auction site with the lowest price; and executes said automatic bidding for the determined auction site.

15. An auction system according to claim 14, further comprising:
a comparing portion configured to compare the highest bidding price of another person and said bidding price in said auction site determined by said site determining portion;
an addition portion configured to add said increase amount to said bidding price if said bidding price is lower than said highest bidding price of another person in a comparison result by said comparing portion; and
a re-bidding portion configured to execute a re-bidding in a range not exceeding said maximum bidding price using a bidding price after addition by said addition portion.

16. An auction system according to claim 12, further comprising a successful-bid notification portion configured to output a successful-bid notification including at least said auction site information and successful-bidding price information of said auction site for which a successful bid was made if the bid of the corresponding product was successful by automatic bidding by said automatic bidding portion.

17. An auction system according to claim 12, further comprising an end notification portion configured to output, when said auction has ended without making a successful bid of the corresponding product by an automatic bidding by said automatic bidding portion within an auction period, an end notification of the fact.

18. An auction system according to claim 16, further comprising an invalidation processing portion configured to invalidate, when the successful-bid notification was output by said successful-bid notification portion or when said end notification was output by said end notification portion, thereafter an automatic bidding function of said automatic bidding portion by a radio communication with said RFID tag for auction bids through said antenna device.

19. A server for auction bids connected to an apparatus for communicating with a RFID tag configured to perform a radio communication through an antenna device with a RFID tag for auction bids having a RFID circuit element provided with an IC circuit part configured to store information and a tag antenna connected to said IC circuit part, comprising:
an information input portion configured to input address information of each of a plurality of auction sites, personal identification information and password owned by said operator for participating in an auction site, product identification information, quantity information, and bidding price information acquired by said apparatus for communicating with a RFID tag from said RFID tag for auction bids through said antenna device;
a participation processing portion configured to access each of said plurality of auction sites based on said address information input by said information input portion and to execute a participation processing to each auction site using said corresponding personal identification information and said password, respectively; and
an automatic bidding portion configured to make an automatic bid in an auction site for which the participation processing by said participation processing portion has been completed using said product identification information, said quantity information, and said bidding price information.
